(19) United States
(12) Patent Application Publication
(10) Pub. No.: US 2014/0186085 A1
(43) Pub. Date: Jul. 3, 2014

(54) PRESS KEY

(71) Applicant: CHANGSHU SUNREX TECHNOLOGY CO., LTD., Changshu (CN)

(72) Inventor: Qing ZHANG, Changshu (CN)

(73) Assignee: Changshu Sunrex Technology Co., Ltd., Changshu (CN)

(21) Appl. No.: 13/732,740

(22) Filed: Jan. 2, 2013

(51) Int. Cl. B41J 5/10

(52) U.S. Cl. CPC B41J 5/10
USPC 400/490

(57) ABSTRACT

A press key includes: a base plate; a key cap including a top plate and a frame, the frame having a frame wall that surrounds a frame opening and that is formed with upper journal retention members and upper slide retention members; and a restoring unit including first and second support members. The first and second support members have upper end portions and lower end portions. The first and second support members extend through the frame opening. The upper end portion of the first support member is pivotally retained between the upper journal retention members and the top plate. The upper end portion of the second support member is slidably retained between the upper slide retention members and the top plate.

### BACKGROUND OF THE INVENTION

1. Field of the Invention

This invention relates to a press key, more particularly to a miniaturized press key.

2. Description of the Related Art

A conventional keyboard comprises a casing and a plurality of press keys disposed on the casing. Referring to FIGS. 1 and 2, each of the press keys includes a base plate 11, a restoring unit 12 disposed on the base plate 11, and a key cap 13 disposed on the restoring unit 12.

The base plate 11 is formed with a pair of lower journal retention members 111, and a pair of lower slide retention members 112. The restoring unit 12 has a scissors linkage 121 that connects the key cap 13 to the base plate 11, and an elastic member 122 that is disposed between the base plate 11 and the key cap 13. The key cap 13 includes a flat top plate 131, a pair of upper journal retention members 138 extending from the top plate 131 toward the base plate 11 and corresponding to the lower journal retention members 111 of the base plate 11, and a pair of upper slide retention members 137 formed on the top plate 131 and corresponding to the lower slide retention members 112 of the base plate 11.

The key cap 13 is capable of being vertically moved between a normal position and a pressed position. When the key cap 13 is pressed from the normal position toward the pressed position, a restoring force is accumulated by the elastic member 122 of the restoring unit 12. The lower journal and slide retention members 111, 112 of the base plate 11 and the upper slide and journal retention members 137, 138 of the key cap 13 limit the scissors linkage 121 of the restoring unit 12 between the normal position and the pressed position. The key cap 13 is uniformly supported by and associated with the scissors linkage 121.

An overall thickness of the press key is approximately equal to a sum of the thicknesses of the top plate 131, the scissors linkage 121, and the base plate 11. Moreover, since a sufficient structural strength should be provided by the top plate 131 for forming the upper slide and journal retention members 137, 138, the top plate 131 of the key cap 13 is required to have an adequate thickness in order to provide such structural strength.

### SUMMARY OF THE INVENTION

Therefore, an object of the present invention is to provide a press key that can overcome the aforesaid drawbacks associated with the prior art.

According to one aspect of this invention, a press key comprises: a base plate; a key cap including a top plate and a frame attached to a bottom side of the top plate, the frame having a frame wall that surrounds a frame opening and that is formed with a pair of upper journal retention members and a pair of upper slide retention members; and a restoring unit disposed on the base plate, and including a first support member, and a second support member connected pivotally to the first support member in a scissors manner, the first and second support members having upper end portions and lower end portions, the lower end portions being connected movably to the base plate, the first and second support members extending through the frame opening, the upper end portion of the first support member being pivotally retained between the upper journal retention members and the top plate, and such that the upper end portion of the second support member being slidably retained between the upper slide retention members and the top plate.

According to another aspect of this invention, a keyboard comprises:
a casing; and
a plurality of press keys, each of which includes:
   a base plate;
   a key cap including a top plate and a frame attached to a bottom side of the top plate, the frame having a frame wall that surrounds a frame opening and that is formed with a pair of upper journal retention members and a pair of upper slide retention members; and
   a restoring unit disposed on the base plate, and including a first support member and a second support member connected pivotally to the first support member in a scissors manner, the first and second support members having upper end portions and lower end portions, the lower end portions being connected movably to the base plate, the first and second support members extending through the frame opening, the upper end portion of the first support member being pivotally retained between the upper journal retention members and the top plate, the upper end portion of the second support member being slidably retained between the upper slide retention members and the top plate.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a conventional press key;

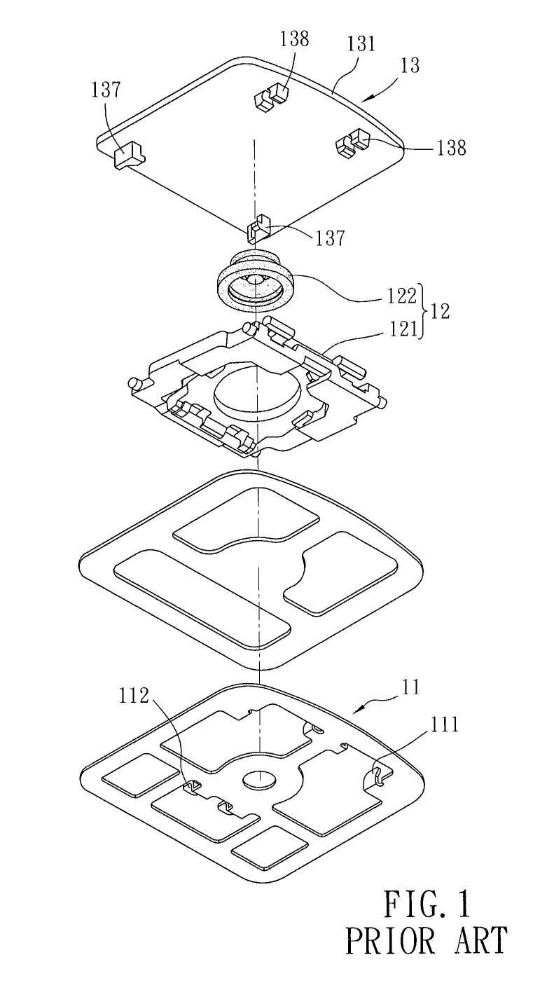

FIG. 2 is a sectional view of the conventional press key;

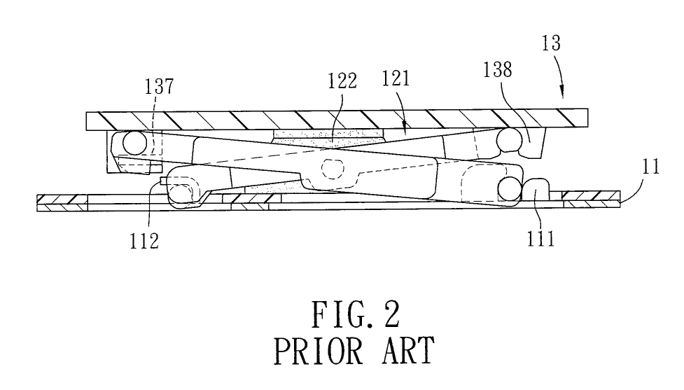

FIG. 3 is a perspective view of the preferred embodiment of a keyboard according to this invention;

FIG. 4 is an exploded perspective view of the first preferred embodiment of a press key according to this invention;

FIG. 5 is a sectional view illustrating the press key of the first preferred embodiment at a normal position;

FIG. 6 is a sectional view illustrating the press key of the first preferred embodiment at a pressed position;

FIG. 7 is an exploded perspective view illustrating a key cap of the first preferred embodiment, which includes a frame and a top plate; and

FIG. 8 is an exploded perspective view illustrating a key cap of the second preferred embodiment according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

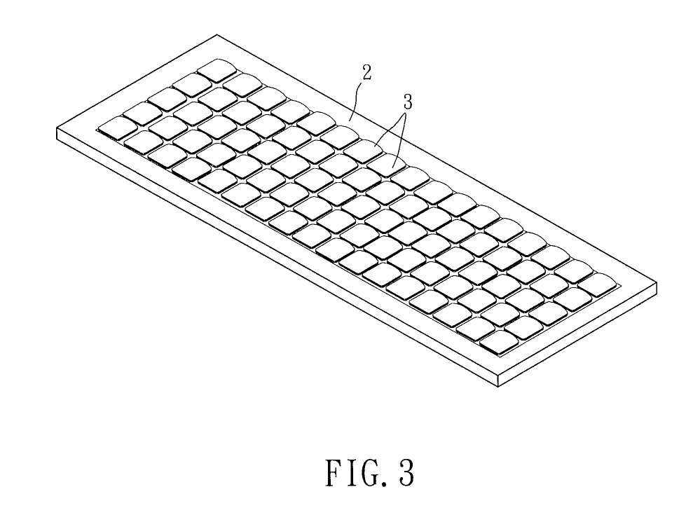

FIG. 3 is a perspective view of the preferred embodiment of a keyboard according to this invention. The keyboard comprises a casing 2 and a plurality of press keys 3 disposed on the casing 2. The press keys 3 can be pressed to generate signals which are to be transmitted to a processor (not shown).

For the sake of brevity, only one of the press keys 3 is illustrated in the figures.

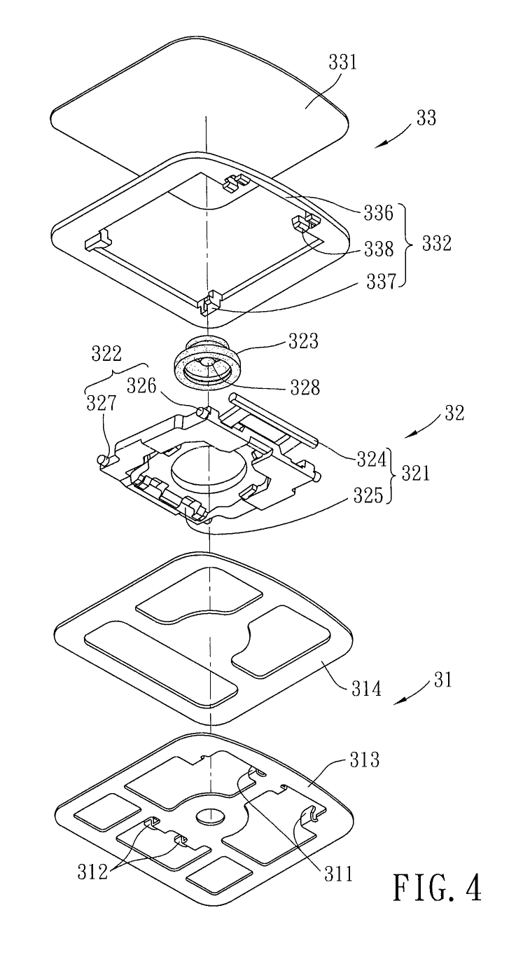

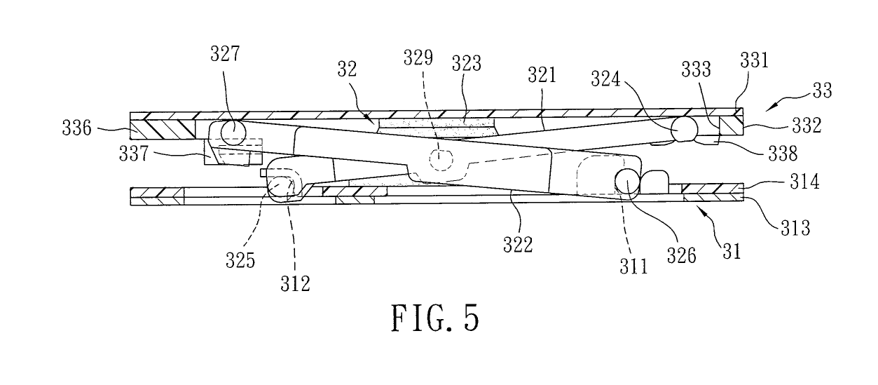

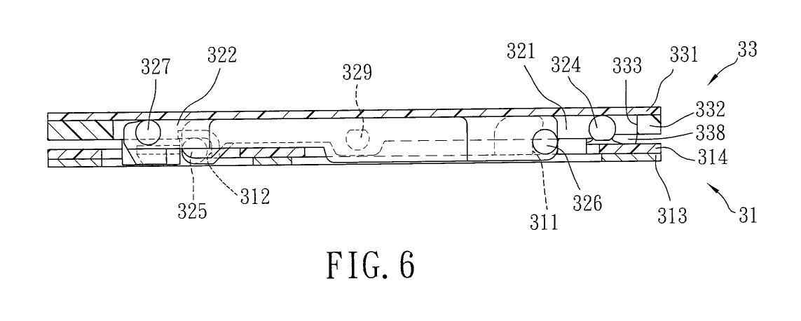

FIG. 4 is an exploded perspective view of the first preferred embodiment of the press key 3 according to this invention. FIG. 5 is a sectional view illustrating the press key 3 of the first preferred embodiment at a normal position. FIG. 6 is a sectional view illustrating the press key 3 of the first preferred embodiment at a pressed position. Each of the press keys 3 comprises: a base plate 31, a restoring unit 32 disposed on the base plate 31, and a key cap 33 disposed on the restoring unit 32.

The base plate 31 includes a pair of lower journal retention members 311 and a pair of lower slide retention members 312 spaced apart by a predetermined distance from the lower journal retention members 311. In the first preferred embodiment, the base plate 31 further includes a metal substrate 313 and a membrane 314 disposed on the metal substrate 313 and partly exposing the metal substrate 313. The lower journal retention members 311 and the lower slide retention members 312 are formed in one piece with the metal substrate 313 by stamping and bending. The membrane 314 is disposed on a surface of the metal substrate 313 such that the lower journal retention members 311 and the lower slide retention members 312 protrude therethrough. Alternatively, the base plate 31 can have one lower journal retention member 311 and one lower slide retention member 312.

The key cap 33 includes a top plate 331 and a frame 332 attached to a bottom side of the top plate 331. The frame 332 has a frame wall 336 that surrounds a frame opening 333 and that is formed with a pair of upper journal retention members 338 and a pair of upper slide retention members 337. The number of the upper journal retention members 338 and the upper slide retention members 337 may vary based on actual requirements.

The restoring unit 32 is disposed on the base plate 31 and includes a first support member 321 and a second support member 322 connected pivotally to the first support member 321 in a scissors manner. The key cap 33 is connected to the base plate 31 through the first and second support members 321, 322. The restoring unit 32 includes an elastic element 323 which provides a restoring force and which is disposed between the base plate 31 and the top plate 331. The first and second support members 321, 322 are pivotally connected to each other through a pivot axis 329 and have upper end portions and lower end portions. The lower end portions are connected movably to the base plate 31. The first and second support members 321, 322 extend through the frame opening 333. The upper end portion of the first support member 321 is pivotally retained between the upper journal retention members 338 and the top plate 331. The upper end portion of the second support member 322 is slidably retained between the upper slide retention members 337 and the top plate 331.

Specifically, the upper end portion of the first support member 321 has a first upper pin 324 pivotally connected to the key cap 33 at the upper journal retention members 338. The lower end portion of the first support member 321 has a first lower pin 325 slidably connected to the lower slide retention members 312 of the base plate 31. The lower end portion of the second support member 322 has a second lower pin 326 pivotally connected to the lower journal retention members 311 of the base plate 31. The upper end portion of the second support member 322 has a second upper pin member 327 slidably connected to the key cap 33 at the upper slide retention members 337.

In this embodiment, the second lower pin 326 has a projection formed on a plane of the first support member 321 between the pivot axis 329 and the first upper pin member 324. The first lower pin member 325 has a projection formed on a plane of the second support member 322 between the pivot axis 329 and the second upper pin 327. In this embodiment, the first support member 321 is formed with a through hole. The elastic element 323 is disposed in the through hole of the first support member 321 and has a contact portion 328. When the contact portion 328 of the elastic element 323 is pressed, an electrical signal may be thus generated in a conventional manner. In this embodiment, the elastic element 323 is a rubber dome.

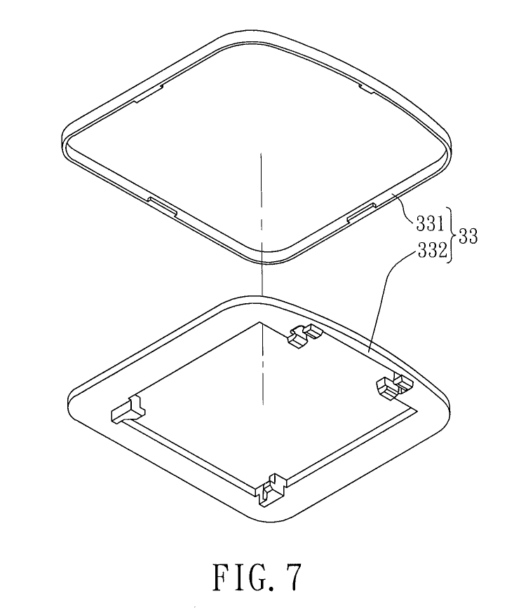

The key cap 33 further has one of an adhesive connection, a melt bonding connection, and an interlocking connection between the top plate 331 and the frame 332 to connect the top plate 331 and the frame 332 (see FIG. 7). Specifically, the frame 332 of the key cap 33 is adhered to, hot melted to, or embedded into the top plate 331. The first and second support members 321, 322 can be partially accommodated in the frame opening 333 and are not obstructed by the frame wall 336.

When the key cap 33 is at a normal position, the restoring unit 32 provides a restoring force for keeping the key cap 33 away from the base plate 31. When a force is applied to press the top plate 331 of the key cap 33, the key cap 33 is moved toward the first lower pin 325 of the first support member 321 and the second lower pin 326 of the second support member 322 until the contact portion 328 of the elastic element 323 contacts a circuit board not shown to generate an electrical signal (the key cap 33 is at a pressed position at this time). When the force applied on the key cap 33 is released, the key cap 33 is moved from the pressed position back to the normal position.

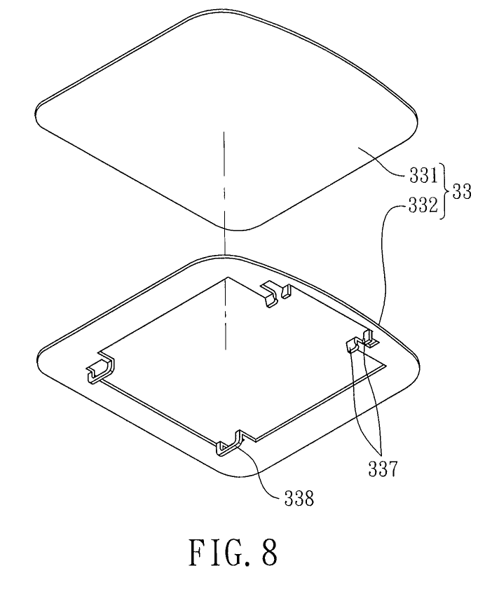

FIG. 8 is an exploded view illustrating the key cap 33 of the second preferred embodiment according to this invention. The second preferred embodiment is similar to the first preferred embodiment except that the frame 332 of the key cap 33 is a stamped metal plate. The key cap 33 further has a welding connection or an adhesive connection between the frame 332 and the top plate 331. The upper slide and journal retention members 337, 338 are formed by bending the stamped metal plate of the frame 332.

To sum up, in this invention, with formation of the frame opening 333 defined by the frame 332, the first and second support members 321, 322 can be partially accommodated in the frame opening 333, especially, in the case of the pressed position, where the first and second support members 321, 322 are almost entirely accommodated in the frame opening 333. Thus, the press key 3 has a relatively thin thickness compared to that of the prior art. Besides, since the frame 332 is hollow, the key cap 33 can have weight and material costs can be lowered. Moreover, the upper slide and journal retention members 337, 338 are formed on the frame wall 336 of the frame 332 rather than on the top plate 331, and thus the thickness of the top plate 331 of the key cap 33 can be reduced accordingly.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A press key, comprising:
a base plate;
a key cap including a top plate and a frame attached to a bottom side of said top plate, said frame having a frame wall that surrounds a frame opening and that is formed with a pair of upper journal retention members and a pair of upper slide retention members; and
a restoring unit disposed on said base plate, and including a first support member and a second support member connected pivotally to said first support member in a scissors manner, said first and second support members having upper end portions and lower end portions, said lower end portions being connected movably to said base plate, said first and second support members extending through said frame opening, said upper end portion of said first support member being pivotally retained between said upper journal retention members and said top plate, said upper end portion of said second support member being slidably retained between said upper slide retention members and said top plate.

2. The press key of claim 1, wherein said first and second support members are connected pivotally to each other through a pivot axis and at an intersection of said first and second support members, said restoring unit further including an elastic element which provides a restoring force and which is disposed between said base plate and said top plate, said upper end portion of said first support member having a first upper pin pivotally connected to said key cap, said lower end portion of said first support member having a first lower pin slidably connected to said base plate, said upper end portion of said second support member having a second upper pin slidably connected to said key cap, said lower end portion of said second support member having a second lower pin pivotally connected to said base plate, said second lower pin having a projection formed on a plane of said first support member between said pivot axis and said first upper pin member, said first lower pin having a projection formed on a plane of said second support member between said pivot axis and said second upper pin member.

3. The press key of claim 2, wherein said base plate has a lower slide retention member to which said first lower pin is slidably connected, and a lower journal retention member to which said second lower pin is pivotally connected.

4. The press key of claim 1, wherein said key cap further has one of an adhesive connection, a melt bonding connection and an interlocking connection between said top plate and said frame.

5. The press key of claim 1, wherein said frame of said key cap is a stamped metal plate, said key cap further having one of a welding connection and an adhesive connection between said stamped metal plate and said top plate.

6. A keyboard comprising:
a casing; and
a plurality of press keys, each of which includes:
a base plate;
a key cap including a top plate and a frame attached to a bottom side of said top plate, said frame having a frame wall that surrounds a frame opening and that is formed with a pair of upper journal retention members and a pair of upper slide retention members; and
a restoring unit disposed on said base plate, and including a first support member and a second support member connected pivotally to said first support member in a scissors manner, said first and second support members having upper end portions and lower end portions, said lower end portions being connected movably to said base plate, said first and second support members extending through said frame opening, said upper end portion of said first support member being pivotally retained between said upper journal retention members and said top plate, said upper end portion of said second support member being slidably retained between said upper slide retention members and said top plate.

7. The keyboard of claim 6, wherein said first and second support members are connected pivotally to each other through a pivot axis and at an intersection of said first and second support members, said restoring unit further including an elastic element which provides a restoring force and which is disposed between said base plate and said top plate, said upper end portion of said first support member having a first upper pin pivotally connected to said key cap, said lower end portion of said first support member having a first lower pin slidably connected to said base plate, said upper end portion of said second support member having a second upper pin slidably connected to said key cap, said lower end portion of said second support member having a second lower pin pivotally connected to said base plate, said second lower pin having a projection formed on a plane of said first support member between said pivot axis and said first upper pin, said first lower pin member having a projection formed on a plane of said second support member between said pivot axis and said second upper pin.

8. The keyboard of claim 7, wherein said base plate has a lower slide retention member to which said first lower pin is slidably connected, and a lower journal retention member to which said second lower pin is pivotally connected.

9. The keyboard of claim 6, wherein said key cap further has one of an adhesive connection, a melt bonding connection and an interlocking connection between said top plate and said frame.

10. The keyboard of claim 6, wherein said frame of said key cap is a stamped metal plate, said key cap further having one of a welding connection and an adhesive connection between said stamped metal plate and said top plate.
